(19) United States
(12) Patent Application Publication
(10) Pub. No.: US 2025/0028993 A1
(43) Pub. Date: Jan. 23, 2025

(54) REQUEST MANAGEMENT USING MACHINE LEARNING MODELS TRAINED WITH SYNTHETIC DATA AND PSEUDO-LABELED DATA

(71) Applicant: ServiceNow, Inc., Santa Clara, CA (US)

(72) Inventors: Orlando Marquez, Montreal (CA); Hessam Amini, Ottawa (CA); Patrice Bechard, Montreal (CA)

(21) Appl. No.: 18/224,227

(22) Filed: Jul. 20, 2023

(51) Int. Cl. G06N 20/00

(52) U.S. Cl. CPC G06N 20/00

(57) ABSTRACT

A first machine learning model is trained using a synthetic training dataset. The first machine learning model is used to predict a plurality of pseudo-labels corresponding to an unlabeled dataset associated with a specific group. At least a portion of the unlabeled dataset and their corresponding pseudo-labels are selected to form a pseudo-labeled dataset. A second machine learning model is trained using the pseudo-labeled dataset and the synthetic training dataset as an improved version of the first machine learning model.

### BACKGROUND OF THE INVENTION

Data labeling is part of the preprocessing stage when developing a machine learning (ML) model. It requires the identification of raw data (e.g., images, text files, videos), and then the addition of one or more labels to that data to specify its meaning for the models, allowing the machine learning model to make accurate predictions.

Labeled data is used in supervised learning, whereas unlabeled data is used in unsupervised learning. Labeled data is more difficult to acquire and store (i.e., time consuming and expensive) than unlabeled data.

Semi-supervised learning is a branch of machine learning that combines a small amount of labeled data with a large amount of unlabeled data during training. Semi-supervised learning falls between unsupervised learning (with no labeled training data) and supervised learning (with only labeled training data). Semi-supervised learning is designed to address the problems where unlabeled data is abundant and obtaining labeled data is expensive.

### BRIEF DESCRIPTION OF THE DRAWINGS

Various embodiments of the invention are disclosed in the following detailed description and the accompanying drawings.

FIG. 1 illustrates an example of a service request management process 100.

FIG. 2 is a block diagram illustrating an example of a network environment for a service request management system.

FIG. 3 illustrates an exemplary process 300 for supervised training and using a machine learning model for automated classification of service requests.

FIG. 4 illustrates an exemplary process 400 for semi-supervised training and using a machine learning model for automated classification of service requests.

FIG. 5 illustrates an exemplary process 500 for collecting the pseudo-labeled dataset.

FIG. 6 illustrates an exemplary process 600 for training a machine learning model from scratch using both the synthetic training dataset and the pseudo-labeled dataset.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A service request may be defined as a request for service from an employee, customer, or vendor. Service requests generally involve procuring or requesting access to something that is not currently available to the employee, customer, or vendor. Service requests may take many different forms. Examples of service requests include information technology (IT) requests, time-off requests, purchase order authorizations, and the like.

One of the most common types of service requests in an organization are IT requests. An information technology system (IT system) is generally an information system, a communications system, or, more specifically, a computer system-including all hardware, software, and peripheral equipment-operated by a limited group of IT users, and an IT project usually refers to the commissioning and implementation of an IT system.

Employees of an enterprise or members of an organization may have different IT requests. IT requests may be related to problems logging into a device or an account, printing issues, inability to access shared files, missing or deleted files, challenges with online meetings, slow Internet connection, wireless connection problems, a suspected computer virus, a frozen computer, and the like.

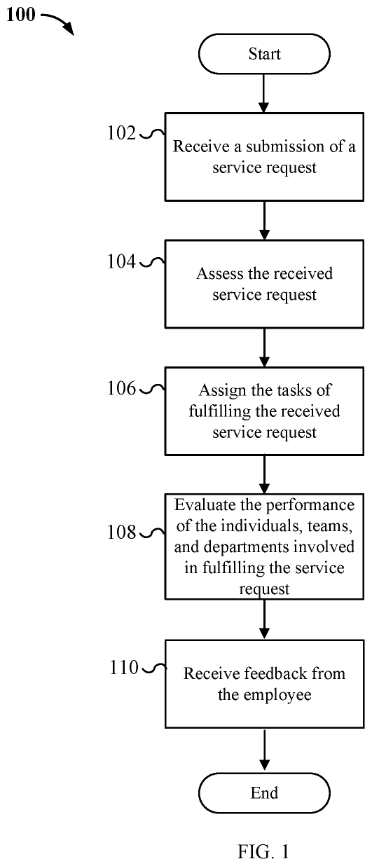

FIG. 1 illustrates an example of a service request management process 100. For example, process 100 may be used to manage IP service requests within an enterprise. However, process 100 may be used to manage other kinds of service requests within an enterprise, such as HR requests, purchase order requests, and the like. At 102, a submission of a service request is received. The service request management process begins when an employee reaches out to submit a service request. This step may be performed using a variety of media. Larger, more established organizations may employ employee portals or mobile-powered applications to help streamline and document the submission process. Some companies instead rely on email, telephone, or even social media to collect request submissions.

At 104, the received service request is assessed. To correctly address a request, the recipient must first understand it. In this step, the relevant team or department assesses the request, determines how urgent it is, what resources or tools will be needed for fulfillment, and whether it requires supervisor approval or verification from IT, human resources (HR), or the applicable business office. Assessment may require multiple employees or departments to participate.

At 106, the tasks of fulfilling the received service request are assigned. With the request fully assessed, departments may now move on to fulfillment. Building off of the information and planning from the assessment phase, departments assign responsibilities, gather important contact information, and establish estimated completion dates.

At 108, the performance of the individuals, teams, and departments involved in fulfilling the service request is evaluated. Once the request has been successfully fulfilled, the request ticket should be closed and archived. Additionally, organizations may wish to take the opportunity to review and evaluate the performance of the individuals, teams, and departments involved in fulfilling the service request.

At 110, feedback from the employee is received. What constitutes fulfilled on the side of the service provider does not always equate to a fulfilling experience on the side of the service user. To help bring these two points into alignment, many organizations will choose to reach out and solicit feedback from the employee once the ticket has been closed. This can be useful not only in confirming that the request has been resolved, but also in demonstrating ongoing commitment to employee success.

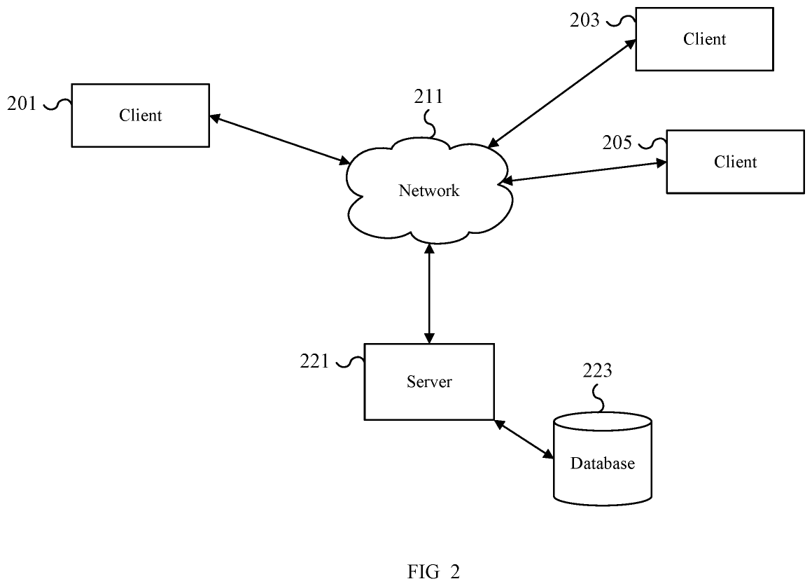

FIG. 2 is a block diagram illustrating an example of a network environment for a service request management system. In the example shown, clients 201, 203, and 205 access services on server 221 via network 211. The services include service request management services that utilize machine learning. Network 211 can be a public or private network. In some embodiments, network 211 is a public network such as the Internet. In various embodiments, clients 201, 203, and 205 are network clients such as web browsers for accessing services provided by server 221. In some embodiments, each of clients 201, 203, and 205 can be a network client running on one of many different computing devices, including laptops, desktops, mobile devices, tablets, kiosks, smart televisions, etc.

In some embodiments, server 221 provides services including web applications for submission of service requests, providing a communication channel between a user and the team assigned to the user's service request, collecting feedback from the users, and the like. Server 221 may be one or more servers including servers for automated classification of service requests using machine learning models. Server 221 may utilize database 223 to provide certain services and/or for storing data associated with the user. For example, database 223 can be a configuration management database (CMDB) used by server 221 for providing customer services and storing customer data. In some embodiments, database 223 stores training data for the machine learning models.

Although single instances of some components have been shown to simplify the diagram, additional instances of any of the components shown in FIG. 2 may exist. For example, server 221 may include one or more servers. As shown in FIG. 2, the servers are simplified as a single server 221. Similarly, database 223 may not be directly connected to server 221, may be more than one database, and/or may be replicated or distributed across multiple components. For example, database 223 may include one or more different databases for each enterprise. As another example, clients 201, 203, and 205 are just a few examples of potential clients to server 221. Fewer or more clients may connect to server 221. In some embodiments, components not shown in FIG. 2 may also exist.

Machine learning models may be utilized to help manage service requests at different steps of process 100, including but not limited to steps 104 and 106 of process 100. One example is using machine learning models for automated classification of service requests. Typically, there are different teams of specialists for handling different types of IT service requests. For example, at a higher level, there are hardware experts and software experts to handle hardware requests and software requests, respectively. At the next level, there are network experts, email experts, server experts, application experts, database experts, and the like. Machine learning models may be used to reliably assign the tasks associated with a service request to the appropriate teams; otherwise, it will result in reduced productivity and dissatisfied users.

For example, at step 102 of process 100, an employee may submit an IT service request with the text description of “Request to add IP whitelist from SFDC email” and the correct classification performed at step 104 of process 100 should be “Email Issues.” In another example, an employee may submit an IT service request with the text description of “Returning to Work-please provision laptop” and the correct classification should be “Hardware Request.” In yet another example, an employee may submit an IT service request with the text description of “We are not able to use Outlook when we are connected with VPN of Zoe Fontana Rome office” and the correct classification should be “Email Issues.”

However, applying traditional machine learning models will likely yield unsatisfactory results for a number of reasons. Enterprises may include companies, businesses, or organizations across different domains. For example, the different domains in the service sector may include retail, tourism, banking, entertainment, and the like. Enterprises in different domains may use a different set of enterprise software and enterprise systems, offer a different set of services, have a different set of service consumers and different types and amounts of data concerning the service requests, etc. Since the software or hardware utilized by employees of different enterprises may differ, the language used by the employees of different enterprises to describe IT service requests may also vary. These domain differences present a challenge for machine learning solutions. Therefore, a traditional machine learning model may not be able to automatically classify IT service requests accurately.

Another challenge is the lack of labeled data. For example, little to no labeled data for a specific enterprise may be available when the service request management process 100 is implemented on a low-code platform. Low-code platforms are designed for professional developers and non-technical business users. They require very little training or experience and use visual-based modeling to streamline the development process. They also allow those with coding experience to dive deeper, coding by hand when needed. A low-code solution requires minimal setup effort by the customer, i.e., the enterprise. This effort takes the form of an evaluation dataset where the customer can assess whether the quality of the solution is acceptable. Machine learning solutions on a low-code platform tend to be out-of-the-box solutions. In the machine learning context, this specifically means little to no data labeling on the customer side.

In the present application, an improved technique to tune out-of-the-box machine learning solutions to specific customer instances using unlabeled data is disclosed. A first machine learning model is trained using a synthetic training dataset. The first machine learning model is used to predict a plurality of pseudo-labels corresponding to an unlabeled dataset associated with a specific group. At least a portion of the unlabeled dataset and their corresponding pseudo-labels are selected to form a pseudo-labeled dataset. A second machine learning model is trained using the pseudo-labeled dataset and the synthetic training dataset as an improved version of the first machine learning model.

The present application discloses an improved technique to tune out-of-the-box machine learning solutions to specific customer instances using unlabeled data. Starting from a synthetic training and a synthetic validation dataset, the improved technique further includes a training technique using pseudo-labels to improve the quality of the machine learning solution when deployed to a specific customer.

The modified and improved pseudo-labeling, semi-supervised learning technique is similar to but different from the traditional pseudo-labeling, semi-supervised learning technique. The improved technique does not need any customer labeled training data, but employs a synthetic training set and a large pool of unlabeled data, which may come from the customer database, such as database 223 in FIG. 2. In some embodiments, the modified technique is a modified pseudo-labeling, semi-supervised learning technique applied to the enterprise setup to 1) improve the initial solution deployed to the customer enterprise as well as to 2) continuously improve the solution after deployment, without any human effort.

The improved technique has many advantages. Labeling is hugely expensive because it requires a large amount of resources, including designers, engineers, and testers. The main benefit to customers is an improvement of their machine learning solution without any labeling effort. The improved technique includes an intent classifier trained on synthetic training and synthetic validation datasets (e.g., synthetic because they are created by linguists). The machine learning task assigns an intent to an IT service request associated with an IT incident based on the text provided by the user requesting the IT service request. For example, an employee may submit an IT service request with the text description of “Returning to Work-please provision laptop” and the correct intent should be classified by the machine learning models as a “Hardware Request.” Another benefit is that the classifier is small and may operate within computing constraints as the improvement comes from better training data, instead of coming from larger machine learning models. Lastly, the improved technique can automatically and continuously improve the quality of the machine learning results by tuning it to the customer data found in the customer's location. This requires no additional effort from customers as unlabeled data is used.

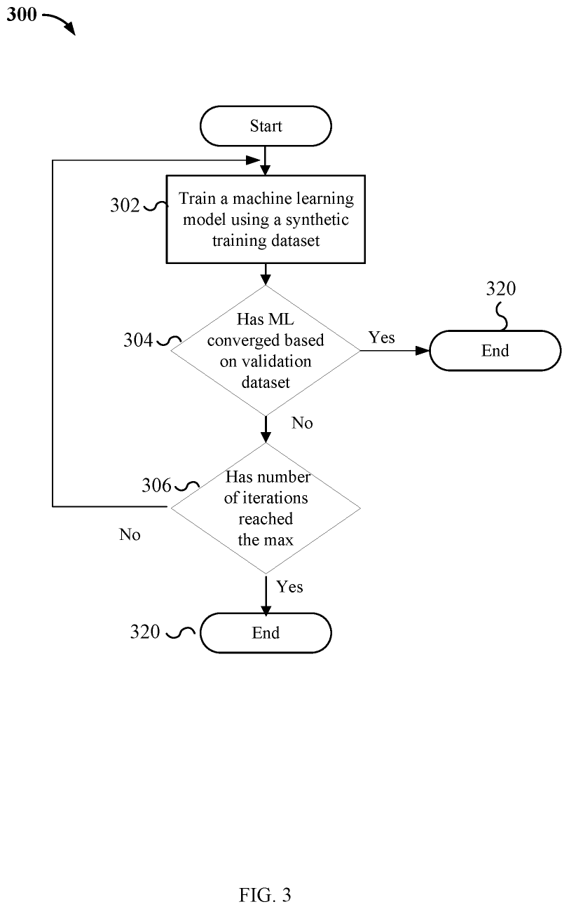

FIG. 3 illustrates an exemplary process 300 for supervised training and using a machine learning model for automated classification of service requests. In some embodiments, process 300 may be performed by server 221 of FIG. 2, which may include one or more servers, including servers for automated classification of service requests using machine learning models.

At step 302, a machine learning model is trained using a synthetic training dataset. The machine learning model may be a neural network, such as a multilayer perception (MLP) that is a fully connected multi-layer neural network. The synthetic training dataset is featurized labeled data. In some embodiments, the synthetic training dataset is created to be used across different enterprises. Synthetic training data is information that is artificially generated rather than produced by real-world events. In some embodiments, the synthetic training dataset may be created by an algorithm or a computer simulation. In some embodiments, the synthetic training dataset may be created by a human agent, such as a linguist who is experienced in the language used in the IT field. An agent or a computer program may create a synthetic taxonomy (intent-utterance map) as a synthetic training dataset, which is an approximation that tries to capture the real distribution of the text or utterances that users may use to report IT incidents and initiate IT requests. For example, there is a plurality of IT incidents and IT requests that a user of an organization or enterprise may intend to report to the service request management system. The plurality of IT incidents and IT requests may be classified into a plurality of IT incidents and requests classifications. For each classification and a corresponding label, a plurality of text strings or utterances to report the particular IT incident or initiate the IT request may be created by the agent or the computer program.

Examples of the classification “Hardware Request” may include the text strings “Temporary laptop request,” “Need another headset,” “New adapter,” “Need a bigger monitor,” and the like. Examples of the classification “Software Install” may include the text strings “Get OneNote on phone,” “Need adobe acrobat on phone,” “Download adobe flash player,” and the like. In some embodiments, a classification of “No Intent” is used to classify the incidents that are not related to IT incidents or IT requests. For example, the classification “No Intent” may include the text strings “devops deployment failure,” “Blacklisting of ip,” “Discount request,” and the like.

IT incidents and IT requests may also be classified to be handled by different IT teams based on areas of expertise. Examples of the classification label “Network Issues” may include the text strings “Wi-Fi failed to connect,” “Cannot search on Google,” and “Cannot open the network drive.” Examples of the classification “Email Issues” may include the text strings “Not able to receive emails” and “Customer emails are going to spam folder.”

At 304, it is determined whether the machine learning model trained using the synthetic training dataset has converged based on a validation dataset (e.g., a synthetic validation dataset). The machine learning model is determined to reach convergence when the validation metric, such as precision or F1 score, stops improving. In particular, the machine learning model that has been trained with the synthetic training dataset is used to predict the responses for the observations in the validation dataset. Validation datasets may be used for regularization via early stopping (i.e., stopping training when the error of the validation dataset increases, as this is a sign of over-fitting).

If the machine learning model trained using the synthetic training dataset has converged based on the validation dataset, then process 300 proceeds to 320 and the process is terminated. If the machine learning model trained using the synthetic training dataset has not converged based on the validation dataset, then process 300 proceeds to 306.

At 306, it is determined whether the maximum number of iterations of training the machine learning model has been reached. As there is generally a fixed computing budget, it is necessary to set an upper limit for iterations. If the maximum number of iterations has been reached, then process 300 proceeds to 320, and the process is terminated. If the maximum number of iterations has not been reached, then process 300 proceeds back to 302, and the training of the machine learning model is continued (e.g., train for more epochs or use different hyper-parameters).

The machine learning model trained using the synthetic training dataset provides an initial basic model to start with. As will be described in greater detail below, the initial basic ML model is used to predict the unlabeled incidents from a specific enterprise. The initial basic ML model is used to generate the pseudo-labeled dataset from the real unlabeled data collected from a specific enterprise. And then a new machine learning model is trained based on the pseudo-labeled dataset and the synthetic training dataset, which provides a performance improvement in predicting the real data at the enterprise.

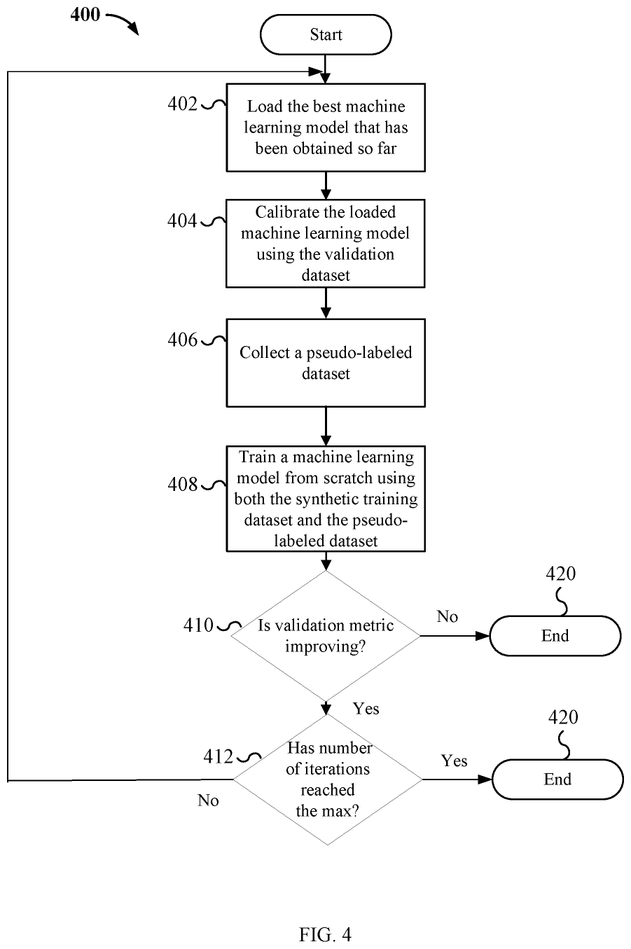

FIG. 4 illustrates an exemplary process 400 for semi-supervised training and using a machine learning model for automated classification of service requests. In some embodiments, process 400 may be performed by server 221 of FIG. 2, which may include one or more servers, including servers for automated classification of service requests using machine learning models. Process 400 is performed while the validation metric is improving and the maximum number of iterations is not reached yet.

At 402, the best machine learning model that has been obtained so far is loaded. For example, when process 400 first begins, the machine learning model is the initial basic machine learning model that is trained using the synthetic training dataset. And as process 400 is repeated over time, the machine learning model that provides the most accurate predictions is loaded.

At 404, the loaded machine learning model is calibrated using the validation dataset. A machine learning model may have errors in making predictions. A machine learning model is calibrated if it produces calibrated probabilities. More specifically, probabilities are calibrated where a prediction of a class with confidence p is correct 100*p percent of the time. The expected calibration error (ECE) can be used to quantify how well a given model is calibrated. Only predictions above a certain predetermined threshold of confidence are used.

At 406, a pseudo-labeled dataset is collected. In general, pseudo-labeling is the process of using the machine learning model to predict labels for featurized unlabeled data. In particular, at first, a model is trained with a dataset containing labels, and that model is used to generate pseudo-labels for an unlabeled dataset. Here, the calibrated machine learning model is used to predict the pseudo-labels for the real unlabeled data (e.g., one epoch of unlabeled data) for a specific group, such as a specific enterprise. These results of the calibrated machine learning model with predictions above a certain predetermined threshold of confidence are collected to form the pseudo-labeled dataset, which includes the real unlabeled data and their corresponding pseudo-labels. If the machine model is improving, then the quality of the pseudo-labels should increase.

At 408, a machine learning model is trained from scratch using both the synthetic training dataset and the pseudo-labeled dataset. The newly trained model may be used to predict additional unlabeled data of the specific enterprise.

At 410, it is determined whether the validation metric is improving. A machine learning model is determined to reach convergence when the validation metric stops improving. If the validation metric is no longer improving, then process 400 proceeds to 420 and the process is terminated. If the validation metric is still improving, then process 400 proceeds to 412.

At 412, it is determined whether the maximum number of iterations of training the machine learning model has been reached. If the maximum number of iterations has been reached, then process 400 proceeds to 420 and the process is terminated. If the maximum number of iterations has not been reached, then process 400 proceeds back to 402 and process 400 is continued.

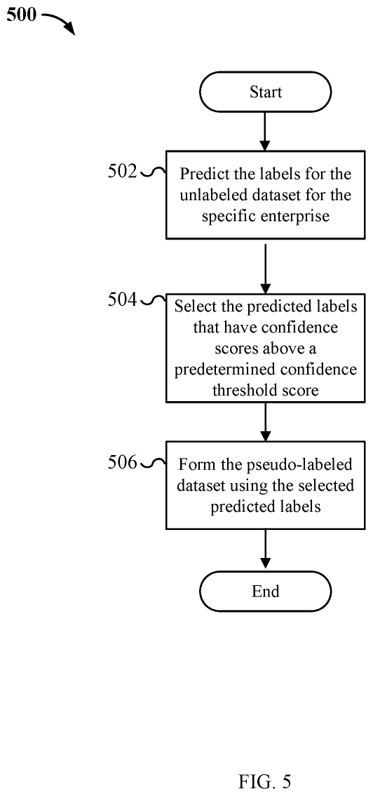

FIG. 5 illustrates an exemplary process 500 for collecting the pseudo-labeled dataset. In some embodiments, process 500 may be performed by server 221 of FIG. 2, which may include one or more servers, including servers for automated classification of service requests using machine learning models. Process 500 may be performed at step 406 of process 400.

At 502, labels for the unlabeled dataset for the specific enterprise are predicted. The calibrated machine learning model is used to predict the labels for the unlabeled dataset for the specific enterprise. The unlabeled dataset includes real incidents that are reported by the employees of the enterprise. For example, an employee may submit an IT service request with the text description of “Request to add IP whitelist from SFDC email” and the correct label should be “Email Issues.” In another example, an employee may submit an IT service request with the text description of “Returning to Work-please provision laptop” and the correct label should be “Hardware Request.” In yet another example, an employee may submit an IT service request with the text description of “We are not able to use Outlook when we are connected with VPN of Zoe Fontana Rome office” and the correct label should be “Email Issues.”

At 504, the predicted labels for the unlabeled dataset for the specific enterprise that have confidence scores above a predetermined confidence threshold score are selected. For example, the predetermined confidence threshold score is set at 90%, and the prediction of a class with confidence 90% is correct 90% of the time, and the corresponding predicted labels are selected. At 506, the pseudo-labeled dataset is formed using the selected predicted labels selected at 504.

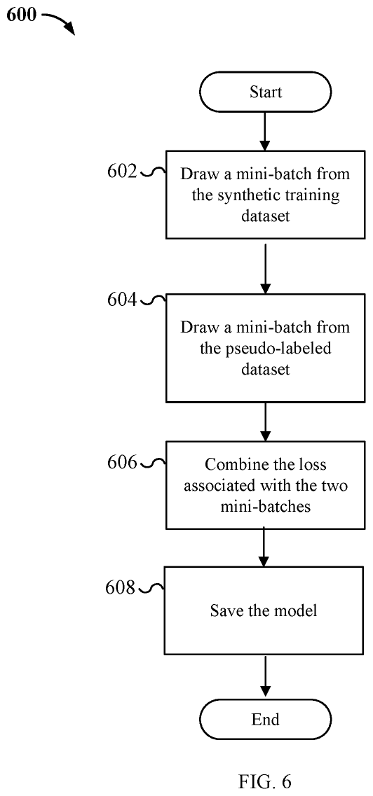

FIG. 6 illustrates an exemplary process 600 for training a machine learning model from scratch using both the synthetic training dataset and the pseudo-labeled dataset. In some embodiments, process 600 may be performed by server 221 of FIG. 2, which may include one or more servers, including servers for automated classification of service requests using machine learning models. Process 600 may be performed at step 408 of process 400.

At 602, a mini-batch is drawn from the synthetic training dataset. Using an epoch is when all the training data is used at once. Instead of using an epoch, a subset or subsample is drawn from the synthetic training dataset each time. In some embodiments, a mini-batch includes 16, 24, or 32 labeled data points.

At 604, a mini-batch is drawn from the pseudo-labeled dataset. For example, the mini-batch is a subset or subsample drawn from the pseudo-labeled dataset each time. In some embodiments, a mini-batch includes 16, 24, or 32 pseudo-labels.

At 606, the loss associated with the synthetic mini-batch and the loss associated with the pseudo-labeled mini-batch are combined. One problem with combining synthetic data with real data is that the two types of data come from two different distributions, and combining the two may cause the machine learning model not to be able to train effectively. In some embodiments, the initial training assigns more weight to the synthetic data and less weight to the pseudo-labeled data, and then progressively, the training assigns more weight to the pseudo-labeled data and less to the synthetic data. For example, the combined loss is a weighted sum of the loss associated with the synthetic mini-batch and the loss associated with the pseudo-labeled mini-batch:

$$L = {L}_{x} + {λ}_{r} {L}_{r} \qquad Equation ( 1 )$$

where L is the combined loss
Lₓ is the loss associated with the synthetic data
Lᵣ is the loss associated with the pseudo-labeled data
λᵣ is a scale factor for scaling Lᵣ

The scale factor λᵣ (lambda) of Equation (1) scales the loss associated with the pseudo-labeled data with respect to the loss associated with the synthetic data. The advantage of Equation (1) is that it can stabilize the learning given that the pseudo-labels are noisy. In some embodiments, the weight of the pseudo-labeled loss term may be increased as training progresses, by increasing lambda as training progresses. In some embodiments, lambda is calculated according to how long or how far along the training is.

For example, lambda may be calculated as follows:
If (TRAINING STEP<=UPPER_LIMIT_STEPS) then
   λᵣ=(TRAINING STEP/UPPER_LIMIT_STEPS)*PSEUDO_LABEL_LOSS_WEIGHT
Else
   λᵣ=PSEUDO_LABEL_LOSS_WEIGHT

TRAINING_STEP is a measure of how long or how far along the machine learning model has been training. For example, TRAINING_STEP may be a measure of time or a number of iterations. UPPER_LIMIT_STEPS is a predetermined maximum time or a predetermined maximum number of iterations. Lambda is increased until TRAINING_STEP reaches UPPER_LIMIT_STEPS, where the maximum value of lambda is equal to a predetermined maximum scaling factor value (PSEUDO_LABEL_LOSS_WEIGHT). Both UPPER_LIMIT_STEPS and PSEUDO_LABEL_LOSS_WEIGHT are hyper-parameters that may be determined through experimentation.

At 608, the converged model is saved. Backpropagation is performed. Throughout training, backpropagation performs a backward pass to adjust the model's parameters, aiming to minimize a loss function such as cross-entropy loss. The saved model is loaded at step 402 of process 400.

In some embodiments, the enterprise or the customer does not need to provide any labeled data before the enterprise may deploy the machine learning solution and the request management system. In this case, a synthetic validation dataset may be used to improve the performance. However, the improvements may be greater if the validation dataset is obtained from the customer instance.

The request management system and the improved machine learning techniques may be adapted and updated over time. For example, process 300 may be used to deploy the out-of-the box solution the first time by tuning an initial model. In particular, starting from synthetic training and a synthetic validation dataset, the improved technique uses pseudo-labels to improve the quality of the machine learning solution when deployed to a specific customer. After the above initial deployment, the system may be continuously and automatically tuned and updated by using an updated validation dataset.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
training a first machine learning model using a synthetic training dataset;
using the first machine learning model to predict a plurality of pseudo-labels corresponding to an unlabeled dataset associated with a specific group;
selecting at least a portion of the unlabeled dataset and their corresponding pseudo-labels to form a pseudo-labeled dataset; and
training a second machine learning model using the pseudo-labeled dataset and the synthetic training dataset as an improved version of the first machine learning model.

2. The method of claim 1, further comprising:
creating the synthetic training dataset, wherein the synthetic training dataset includes at least a text string or utterance and a corresponding synthetic label.

3. The method of claim 1, further comprising:
determining whether the first machine learning model or the second machine learning model has converged based on a validation metric associated with a validation dataset.

4. The method of claim 1, further comprising:
calibrating the second machine learning model using a validation dataset.

5. The method of claim 1, further comprising:
selecting the at least a portion of the unlabeled dataset and their corresponding pseudo-labels to form the pseudo-labeled dataset based on confidence scores.

6. The method of claim 1, further comprising:
drawing a subset of the pseudo-labeled dataset;
drawing a subset of the synthetic training dataset; and
combining a loss associated with the subset of the pseudo-labeled dataset and a loss associated with the subset of the synthetic training dataset.

7. The method of claim 6, wherein the combined loss comprises a weighted sum of the loss associated with the subset of the pseudo-labeled dataset and the loss associated with the subset of the synthetic training dataset.

8. The method of claim 7, wherein the weighted sum comprises a scaling factor for scaling the loss associated with the subset of the pseudo-labeled dataset with respect to the loss associated with the subset of the synthetic training dataset.

9. The method of claim 8, further comprising:
increasing the scaling factor as the training of the second machine learning model using the pseudo-labeled dataset and the synthetic training dataset progresses.

10. The method of claim 9, wherein the scaling factor is increased until a measure of time has reached a predetermined maximum time.

11. The method of claim 9, wherein the scaling factor is increased until a number of iterations has reached a predetermined maximum number of iterations.

12. The method of claim 9, wherein the scaling factor is increased until the scaling factor is set to a predetermined maximum scaling factor value.

13. The method of claim 1, wherein the second machine learning model is used for automated classification of service requests for the specific group.

14. A system, comprising:
a processor configured to:
train a first machine learning model using a synthetic training dataset;
use the first machine learning model to predict a plurality of pseudo-labels corresponding to an unlabeled dataset associated with a specific group;
select at least a portion of the unlabeled dataset and their corresponding pseudo-labels to form a pseudo-labeled dataset; and
train a second machine learning model using the pseudo-labeled dataset and the synthetic training dataset as an improved version of the first machine learning model; and
a memory coupled to the processor and configured to provide the processor with instructions.

15. The system of claim 14, wherein the processor is further configured to:
select the at least a portion of the unlabeled dataset and their corresponding pseudo-labels to form the pseudo-labeled dataset based on confidence scores.

16. The system of claim 14, wherein the processor is further configured to:
draw a subset of the pseudo-labeled dataset;
draw a subset of the synthetic training dataset; and
combine a loss associated with the subset of the pseudo-labeled dataset and a loss associated with the subset of the synthetic training dataset.

17. The system of claim 16, wherein the combined loss comprises a weighted sum of the loss associated with the subset of the pseudo-labeled dataset and the loss associated with the subset of the synthetic training dataset.

18. The system of claim 17, wherein the weighted sum comprises a scaling factor for scaling the loss associated with the subset of the pseudo-labeled dataset with respect to the loss associated with the subset of the synthetic training dataset.

19. The system of claim 18, wherein the processor is further configured to:
increase the scaling factor as the training of the second machine learning model using the pseudo-labeled dataset and the synthetic training dataset progresses.

20. A computer program product embodied in a non-transitory computer readable medium and comprising computer instructions for:
training a first machine learning model using a synthetic training dataset;
using the first machine learning model to predict a plurality of pseudo-labels corresponding to an unlabeled dataset associated with a specific group;
selecting at least a portion of the unlabeled dataset and their corresponding pseudo-labels to form a pseudo-labeled dataset; and
training a second machine learning model using the pseudo-labeled dataset and the synthetic training dataset as an improved version of the first machine learning model.
